(19) United States
(12) Patent Application Publication
(10) Pub. No.: US 2024/0087450 A1
(43) Pub. Date: Mar. 14, 2024

(54) EMERGENCY VEHICLE INTENT DETECTION

(71) Applicant: GM Cruise Holdings LLC, San Francisco, CA (US)

(72) Inventor: Burkay Donderici, Burlingame, CA (US)

(21) Appl. No.: 17/944,928

(22) Filed: Sep. 14, 2022

(51) Int. Cl. G08G 1/0965; G08G 1/0967; G08G 1/0969

(52) U.S. Cl. CPC G08G 1/0965; G08G 1/096725; G08G 1/0969

(57) ABSTRACT

The present disclosure generally relates to autonomous vehicle detection of emergency events and, more specifically, to updates in autonomous vehicle behavior based on the detection of an emergency vehicle (EMV) responding to an emergency event. In some aspects, the present disclosure provides a process for receiving sensor data pertaining to an environment of autonomous vehicle (AV), detecting, based on the sensor data, an emergency event in the environment, and identifying, based on the sensor data, an emergency vehicle in the environment. In some aspects, the process can further include steps for determining, based on a behavior of the emergency vehicle, if the emergency vehicle is responding to the emergency event. Systems and computer-readable media are also provided.

### BACKGROUND

### 1. Technical Field

The present disclosure generally relates to autonomous vehicle detection of emergency events and, more specifically, to updates in autonomous vehicle behavior based on the detection of an emergency vehicle (EMV) responding to an emergency event.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) navigation and routing operations, according to some aspects of the present disclosure;

FIG. 2 illustrates an example of a deep learning neural network that can be used to implement an emergency event detection process, according to some aspects of the present disclosure;

FIG. 3 illustrates an example system for implementing emergency event detection, according to some aspects of the present disclosure;

FIG. 4 illustrates an example emergency detector module according to some aspects of the present disclosure;

FIG. 5 illustrates an example of a process for updating AV based on the detection of an emergency vehicle (EMV) response, according to some aspects of the present disclosure;

FIG. 6 illustrates another example of a process for an autonomous vehicle detecting and responding to an emergency event, according to some aspects of the present disclosure; and

FIG. 7 illustrates an example processor-based system with which some aspects of the subject technology can be implemented, according to some aspects of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs0, also known as self-driving cars, driverless vehicles, and robotic vehicles, are vehicles that use sensors to sense the environment and move without human input. Automation technology enables the AVs to drive on roadways and to perceive the surrounding environment accurately and quickly, including obstacles, signs, and traffic lights. In some cases, AVs can be used to pick up passengers and drive the passengers to selected destinations.

Autonomous vehicles commonly share roadways with emergency vehicles (also EMVs or EVs). As used herein, EVs can refer to any vehicle that is equipped to respond to an emergency event, including but not limited to: police vehicles, ambulances, and/or fire trucks, etc. Emergency vehicles may be used by an emergency service (e.g., organizations to ensure public safety which may include police, fire, and emergency medical services) to respond to an incident or emergency event. In some cases, an emergency vehicle may require other traffic participants to deviate from their planned routes, e.g., to make way for EMV access to the emergency event. For example, an emergency vehicle may re-direct other vehicles to change lanes or pull over to the side of the road so that it may reach the emergency event as fast as possible. In some examples, the driver of a manually driven vehicle can visually locate an emergency event or incident and can determine the best course of action to move their vehicle out of the path (also trajectory) of the EMV. In the case of an autonomous vehicle, there is a need for a detecting an emergency event and the corresponding EMV while maximizing the probability that the path of the EMV is unobstructed (e.g., that the AV is not obstructing the path of the EMV attending to the emergency event).

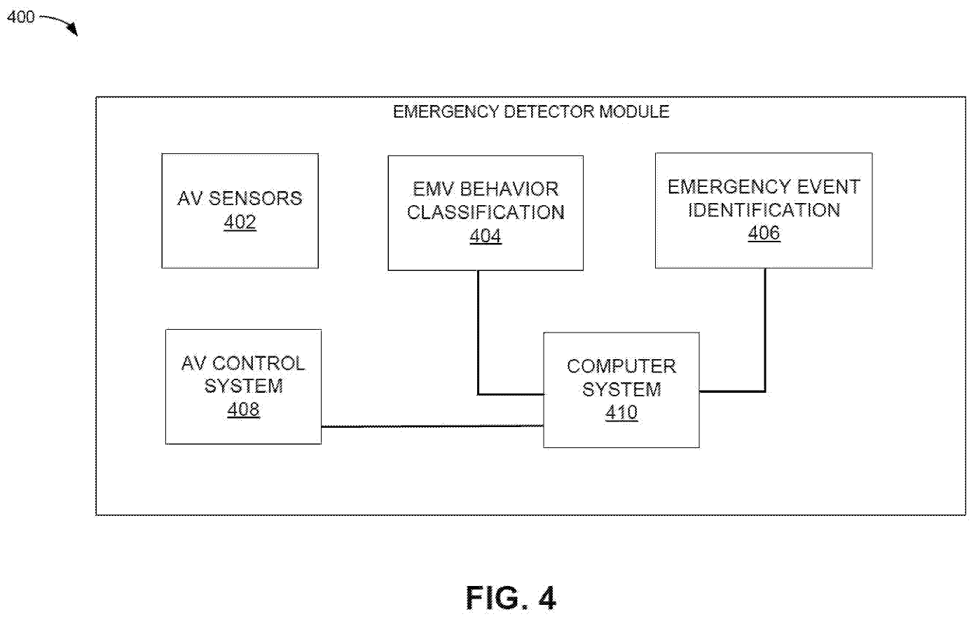

Aspects of the disclosed invention provide solutions relating to AV detection of emergency events and, more specifically, to updates in AV behavior based on the detection of an emergency vehicle (EMV) responding to an emergency event. For example, the AV may update a path or a route to avoid interference with the EMV attending to the emergency event. In some aspects, an emergency detector module (also EDM) associated with the AV may detect (e.g., based on sensor data received by the AV pertaining to the environment) a potential emergency event along with the location and nature of the emergency (e.g., fire, injured person, road obstructions, large crowds, etc.). In addition, the EDM may identify (e.g., using sensor data received by the AV) the type of EMV (which will be discussed in further detail in FIG. 4 below). The EDM may be configured to determine, based on the behavior of the EMV, whether the EMV is responding to the detected emergency event. Finally, once the EDM makes a positive correlation between an emergency event and a corresponding EMV, the AV may update its current trajectory (e.g., the AV may change its path to minimize the probability of interfering with the trajectory of the EMV).

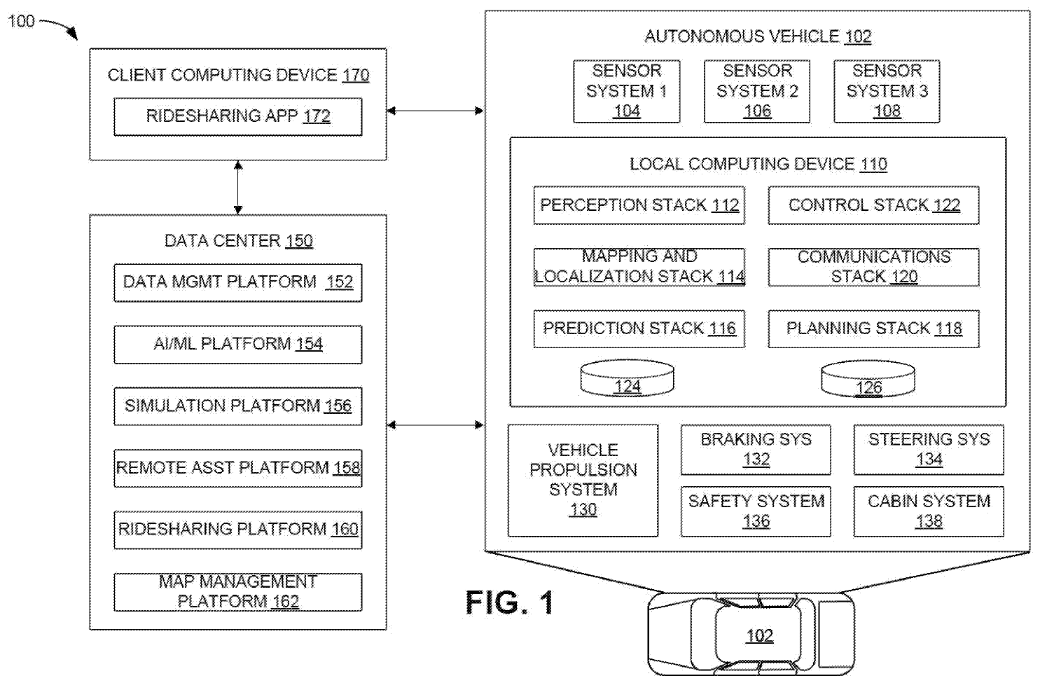

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill in the art will appreciate that such variations do not depart from the scope of the present disclosure.

In this example, the AV management system 100 includes an AV 102, a data center (also autonomous vehicle fleet management device, autonomous vehicle fleet management system, management system) 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack 116 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the mapping and localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, mapping and localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

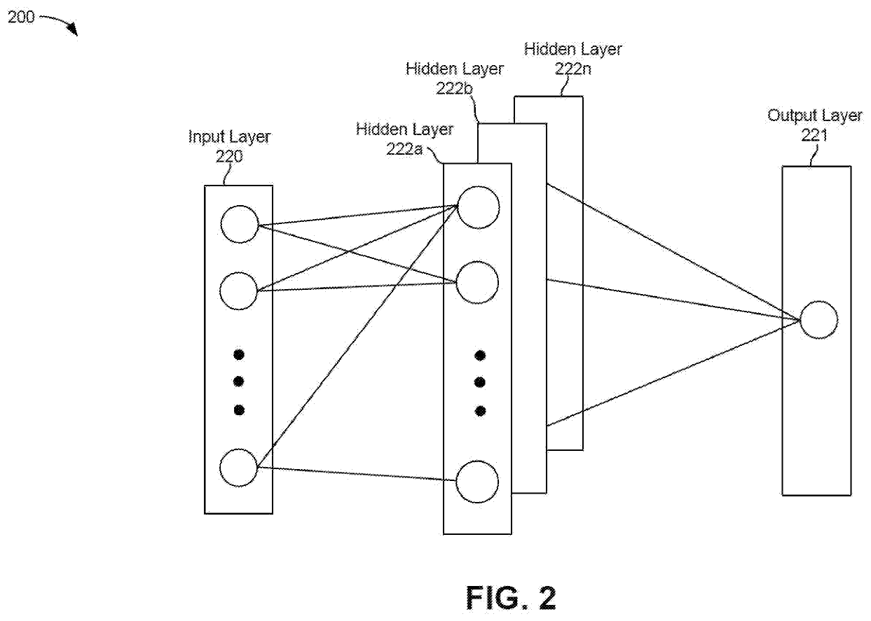

In FIG. 2, the disclosure now turns to a further discussion of models that can be used through the environments and techniques described herein. FIG. 2 illustrates an example of a deep learning neural network 200 that can be used to implement all or a portion of the solutions described herein. For example, neural network 200 can be used to implement a perception module (or perception system) as discussed above. In another example, neural network 200 can be used to detect and respond to an emergency event (e.g., an emergency detector module may receive sensor data pertaining to an environment of an autonomous vehicle, detect an emergency event, identify an emergency vehicle, determine if the emergency vehicle is responding to the emergency event, and update the path of the autonomous vehicle if the emergency vehicle is responding to the emergency event). In some examples, neural network 200 may be implemented at AV 102, data center 150, and/or client computing device 170.

In some examples, an input layer 220 can be configured to receive sensor data and/or data relating to an environment surrounding an AV. The neural network 200 includes multiple hidden layers 222a, 222b, through 222n. The hidden layers 222a, 222b, through 222n include “n” number of hidden layers, where “n” is an integer greater than or equal to one. The number of hidden layers can be made to include as many layers as needed for the given application. The neural network 200 further includes an output layer 221 that provides an output resulting from the processing performed by the hidden layers 222a, 222b, through 222n. In one illustrative example, the output layer 221 can provide estimated treatment parameters, that can be used/ingested by a differential simulator to estimate a patient treatment outcome.

The neural network 200 is a multi-layer neural network of interconnected nodes. Each node can represent a piece of information. Information associated with the nodes is shared among the different layers and each layer retains information as information is processed. In some cases, the neural network 200 can include a feed-forward network, in which case there are no feedback connections where outputs of the network are fed back into itself. In some cases, the neural network 200 can include a recurrent neural network, which can have loops that allow information to be carried across nodes while reading in input.

Information can be exchanged between nodes through node-to-node interconnections between the various layers. Nodes of the input layer 220 can activate a set of nodes in the first hidden layer 222a. For example, as shown, each of the input nodes of the input layer 220 is connected to each of the nodes of the first hidden layer 222a. The nodes of the first hidden layer 222a can transform the information of each input node by applying activation functions to the input node information. The information derived from the transformation can then be passed to and can activate the nodes of the next hidden layer 222b, which can perform their own designated functions. Example functions include convolutional, up-sampling, data transformation, and/or any other suitable functions. The output of the hidden layer 222b can then activate nodes of the next hidden layer, and so on. The output of the last hidden layer 222n can activate one or more nodes of the output layer 221, at which an output is provided. In some cases, while nodes in the neural network 200 are shown as having multiple output lines, a node can have a single output and all lines shown as being output from a node represent the same output value.

In some cases, each node or interconnection between nodes can have a weight that is a set of parameters derived from the training of the neural network 200. Once the neural network 200 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 200 to be adaptive to inputs and able to learn as more and more data is processed.

The neural network 200 is pre-trained to process the features from the data in the input layer 220 using the different hidden layers 222a, 222b, through 222n in order to provide the output through the output layer 221.

In some cases, the neural network 200 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 200 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 200 can perform a backward pass by determining which inputs (weights) most contributed to the loss of the network and can adjust the weights so that the loss decreases and is eventually minimized.

The neural network 200 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 200 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

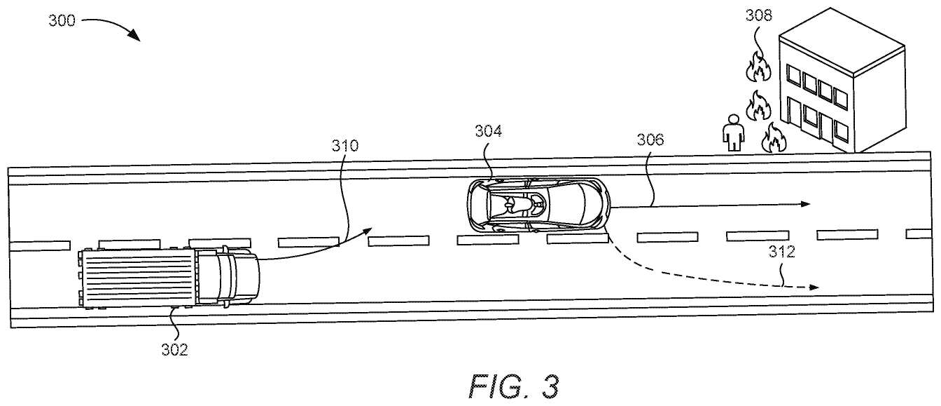

FIG. 3 illustrates an example of an environment 300 in which an emergency event detection process of the disclosed technology may be implemented. Environment 300 includes an EMV 302, AV 304 (e.g., AV 102 illustrated in FIG. 1), and emergency event 308. In some cases, EMV 302 may be responding to emergency event 308. Examples of an emergency event 308 may include, but are not limited to, a collision between two or more vehicles, a fire, a collapsed building, a collapsed roadway, one or more injured pedestrians, or a combination thereof. An emergency event, when detected by the AV 304, may correspond to any phase of the event. For example, in the case of a fire, the emergency event may include an alarm sound coming from a building, smoke coming out of the building, fire coming from the building, emergency services personnel tending to the fire, hoses laid on the ground near the building, emergency personnel moving about the emergency area, etc. In order to respond to emergency event 308, EMV 302 may have a trajectory 310 to reach the emergency event 308. For example, the trajectory 310 may be the fastest or most direct path to reach emergency event 308, or a path to avoid other vehicles on the road. In some examples, EMV 302 may be a manually driven vehicle or an autonomous vehicle (e.g., AV 102 illustrated in FIG. 1). The AV 304 may have a current trajectory 306 and update its current trajectory 306 to a new trajectory 312 to avoid interference with the trajectory 310 of EMV 302. In some aspects, AV 304 may include an emergency detector module (which will be discussed in further detail in FIG. 4) that may receive sensor data pertaining to its respective environment. The emergency detector module may also classify the behavior of EMV 302, identify the type of emergency event 308, and calculate a correlation score to determine whether EMV 302 is responding to the emergency event 308.

In some examples, EMV 302 may include one or more acoustic devices which may notify other vehicles on the road of its presence, and consequently inform the other vehicles to move out of the way of trajectory 310. Examples of acoustic devices may include, but are not limited to, sirens, public address system, air horn, bells, exhaust whistles, or a combination thereof. In addition, EMV 302 may include one or more visual devices which may also notify other vehicles on the road of its presence. For example, a visual device may be a set of light bars comprising one or more lights which flash to warn other vehicles. Further examples of visual devices may include, but are not limited to, beacons, grille lights, dash lights, deck lights, directional warning arrows, information matrix signs, or a combination thereof.

FIG. 4 illustrates an example emergency detector module (EDM) 400 according to some aspects of the present disclosure. In some aspects, EDM 400 may include AV sensors 402, AV control system 408, EMV behavior classification 404, emergency event identification 406, and computer system 410. As discussed above in FIG. 1, AV sensors 402 (e.g., sensor systems 104-108 as illustrated in FIG. 1) receive signals corresponding to the surrounding environment which enable the AV (e.g., AV 304 discussed above in FIG. 3) to navigate roadways autonomously. EDM 400 may also include an AV control system 408, which may include several mechanical systems (e.g., vehicle propulsion system 130, braking system 132, steering system 134, safety system 136, cabin system 138, and other systems as illustrated in FIG. 1) that can be used to maneuver or operate the AV. In some aspects, EDM 400 may also include EMV behavior classification 404 which may identify the location, type, and the behavior of the EMV (e.g., EMV 302 discussed in FIG. 3 above). In some examples, EMV types may include, but are not limited to, law enforcement vehicles (e.g., police car, police motorcycle, police van, police bus, police bicycle, etc.), firefighting vehicles (e.g., fire engine, fire car, fire bike, etc.) and medical vehicles (e.g., ambulance van, ambulance car, ambulance bus, etc.). Examples of EMV behavior may include, but are not limited to, the EMV trajectory (e.g., the path of the EMV as it maneuvers towards an emergency event), visual cues, audible signals, or a combination thereof. EDM 400 may also include emergency event identification 406. Emergency event identification 406 can detect and identify the location and type of an active emergency event. Examples of emergency events may include, but are not limited to, emergencies related to severe weather, fire, hazardous materials, chemical/biological/radiological emergencies, aircraft crashes, war, terrorism, civil disorder, active shooter, collapsed structures, or a combination thereof. Those skilled in the art will appreciate additional examples of events that qualify as an emergency event. In some aspects, EMV behavior classification 404 and emergency event identification 406 can include machine learning algorithms and classification systems similar to the neural network 200 as discussed above in FIG. 2. For example, EMV behavior classification 404 may predict behavior of the EMV (e.g., the EMV path) using machine learning algorithms. In another example, emergency event identification 406 can use machine learning algorithms to determine whether an observed incident qualifies as an emergency.

In some aspects, EMV behavior classification 404 and emergency event identification 406 may be connected to a computer system 410 (e.g., local computing device 110 illustrated in FIG. 1). Computer system 410 may calculate a correlation score to determine whether the EMV is responding to the emergency event. In some examples, computer system 410 may calculate a correlation score using machine learning algorithms (e.g., simulations of actual emergencies and emergency vehicles) and/or probability tables (e.g., a table that probabilistically connects an emergency event with a corresponding EMV). If computer system 410 determines the EMV is responding to an emergency event, then computer system 410 can determine a new trajectory of the AV (e.g., using machine learning algorithms, computer system 410 determines a path to avoid obstruction or disruption of the path of the EMV) and communicate the new trajectory to AV control system 408. AV control system 408 may then adjust the current trajectory (e.g., current trajectory 306 as discussed above in FIG. 3) of the AV to a new trajectory (e.g., new trajectory 312 as discussed above in FIG. 3). Those skilled in the art will appreciate other methods to calculate a correlation score or correlate the EMV with the emergency event.

Computer system 410 may transmit data from emergency detector module 400 using a communication system (e.g., communications stack 120 as illustrated in FIG. 1) to a remote location (e.g., a human operator). Computer system 410 may also receive data from a remote location. For example, computer system 410 may transmit the emergency vehicle type, the emergency vehicle location, the emergency type, the emergency location, and the correlation score which may be displayed to a human operator. In some cases, a human operator may determine a new trajectory (e.g., instead of computer system 410 as discussed above) for the AV, and transmit the new trajectory to computer system 410 which may subsequently transmit the new trajectory to AV control system 408 to adjust the path of the AV.

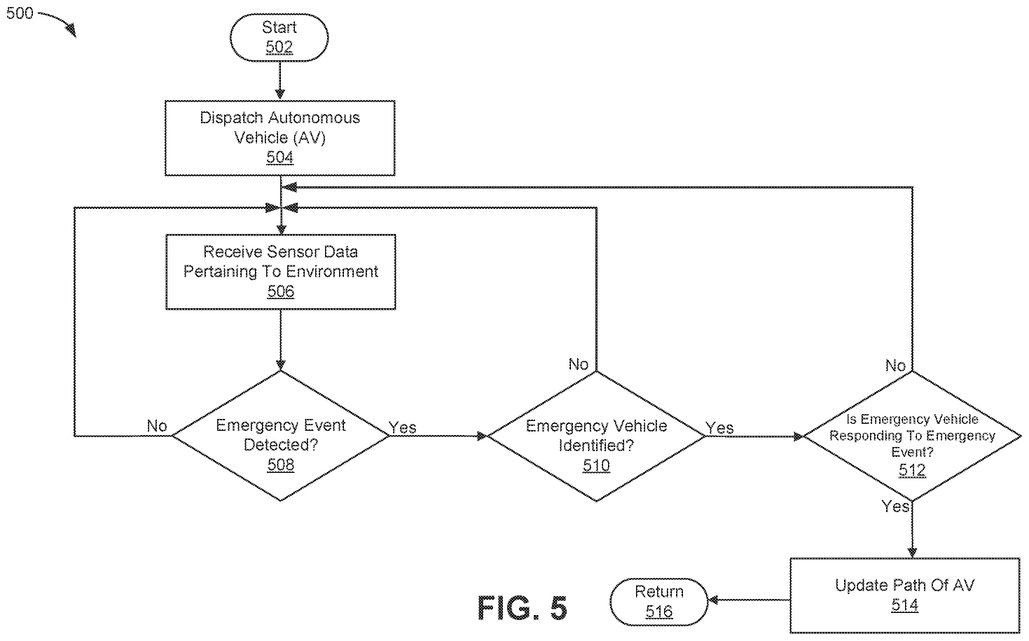

FIG. 5 illustrates an example of a process 500 for an autonomous vehicle detecting and responding to an emergency event. In some examples, process 500 may be performed by emergency detector module 400. In some aspects, process 500 may start at step 502 which may include initializing hardware and software systems associated with an AV (e.g., AV 304). Process 500 may include step 504 in which the AV is dispatched (e.g., to a specific pick-up location) and/or placed in service for responding to ridesharing requests.

At step 506, the AV can receive sensor data pertaining to the environment. For example, AV sensors 402 such as cameras, LIDAR, radar and other sensors (as illustrated above in FIG. 1) enable the AV to drive autonomously, detect emergency events, and identify emergency vehicles.

At step 508, the process 500 determines whether an emergency event has been detected. For example, emergency event identification 406 may use sensor data and machine learning algorithms to determine that an emergency event has not been positively identified during which the process reverts to step 506 to continually use the sensor data to monitor for emergency events. Alternatively, if an emergency event is detected, the process 500 continues to step 510. If the emergency event is not detected, but an emergency vehicle is identified, the sensor systems 104, 106, 108, the perception stack 112 and/or emergency detector module 400 can be operated in a mode that optimizes for detection of the emergency event. For example, articulating sensors can be oriented towards potential event locations (side walks or buildings). If a fire event is being sought, IR cameras may be activated. Additionally, a frequency of one or more sensors may be increased for improved and lower detection latency for the emergency event. The processing range of the perception stack 112 may be increased to allow earlier detection of the emergency event. The detection thresholds of the perception stack 112 may be reduced to allow for earlier detection. The detection threshold of emergency event identification 406 may be reduced.

At step 510, the process 500 determines whether an emergency vehicle is identified. For example, EMV behavior classification 404 may use machine learning algorithms or classification systems to identify the presence of an EMV 302. If an EMV 302 is not identified, the process returns to step 506. If an EMV 302 is positively identified, the process 500 can continue to step 512. Although process 500 illustrates decision block 508 followed by decision block 510, the order may also be reversed (e.g., identifying the emergency vehicle before detecting the emergency event). If an EMV is not identified, but an emergency event is detected, sensor systems 104, 106, 108, perception stack 112, and/or emergency detector module 400 can be operated in a mode that optimizes for detection of the EMV. For example, articulating sensors can be oriented towards potential EMV locations (road intersections). If a fire truck is being sought, cameras or audio sensors may be used to detect the lights or sirens. Frequency of sensors may be increased for improved and lower latency detection of the EMV. The processing range of the perception stack 112 may be increased to allow earlier detection of the EMV. The detection thresholds of the Perception stack 112 may be reduced to allow for earlier detection.

The process 500 continues to step 512 where emergency detector module 400 determines whether the emergency vehicle detected in decision block 510 is responding to the emergency event detected in decision block 508. For example, computer system 410 may use machine learning algorithms and/or calculate a correlation score as discussed above in FIG. 4 to correlate an emergency vehicle to an emergency event. If a determination is made that the emergency vehicle is not responding to the emergency event, the process 500 returns to step 506. Alternatively, if a determination is made that the emergency vehicle is responding to the emergency event, the process 500 continues to step 514. The determination in 512 can be made based on a probability, or correlation score table of emergency event classes and emergency vehicle types, and probably or correlation score of correspondence in each cell of the table. Prediction stack 116 or planning stack 118 may use the probabilities or correlation scores to formulate alternate paths for different determinations. For example prediction stack 116 and/or planning stack 118 can produce one set of paths for the objects in the scene for the EMV corresponding to the emergency event, and another set of paths for the objects in the scene for the EMV not corresponding to the emergency event. In the case of multiple EMV's or multiple detected emergency events, a determination is made regarding which EMV corresponds to which emergency event. This may be a one to one, one to many, or many to one mapping.

At step 514, computer system 410 can determine a new trajectory of the AV and communicate it to AV control system 408 which can update the current trajectory (e.g., current trajectory 306 as discussed above in FIG. 3) of the AV to a new trajectory (e.g., new trajectory 312 as discussed above in FIG. 3) to avoid obstruction or disruption of the path of the EMV. Finally, the process 500 can continue to step 516 in which the process 500 returns to prior processing, which may include repeating the process 500

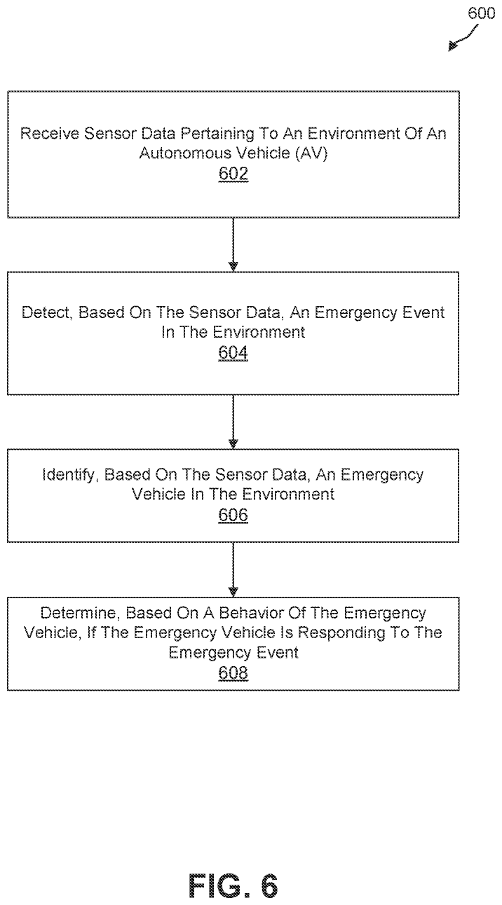

FIG. 6 illustrates another example of a process for an autonomous vehicle detecting and responding to an emergency event. At block 602, the process 600 includes receiving sensor data pertaining to an environment of an autonomous vehicle. For example, emergency detector module 400 can receive sensor data from AV sensors 402.

At block 604, the process 600 includes detecting, based on the sensor data, an emergency event in the environment. For example, emergency event identification 404 can use data from AV sensors 402 and machine learning algorithms to identify and detect an emergency event.

At block 606, the process 600 includes identifying, based on the sensor data, an emergency vehicle in the environment. For example, EMV behavior classification 404 may identify the location, type, and the behavior of the EMV.

At block 608, the process 600 includes determining, based on a behavior of the emergency vehicle, if the emergency vehicle is responding to the emergency event. For example, computer system 410 may use machine learning algorithms and/or probability tables to calculate a correlation score to determine whether the EMV is responding to the emergency event.

In some cases, the process 600 can include updating a path of the AV if the emergency vehicle is responding to the emergency event. For example, computer system 410 may communicate with AV control system 408 to update the current trajectory of the AV (e.g., current trajectory 306 as illustrated in FIG. 3) to a new trajectory (e.g., new trajectory 312 as illustrated in FIG. 3).

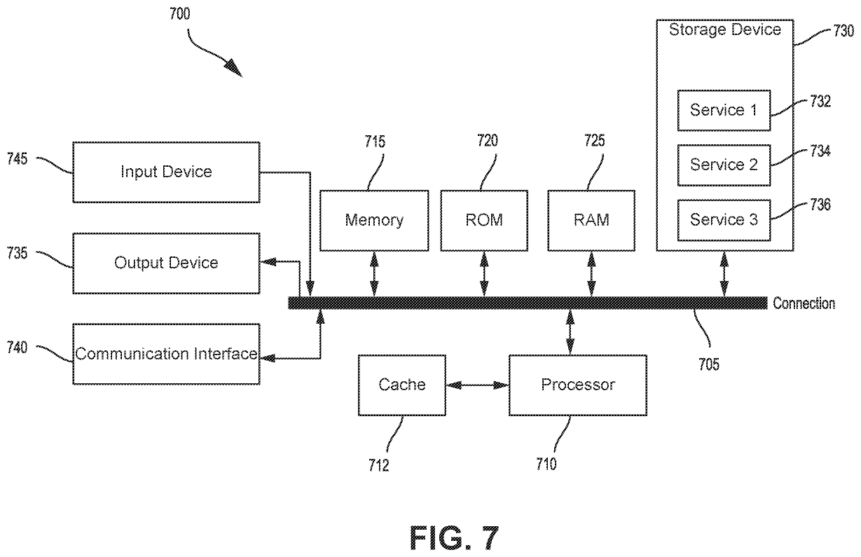

FIG. 7 illustrates an example processor-based system with which some aspects of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative examples of the disclosure include:

Aspect 1. A computer-implemented method comprising: receiving sensor data pertaining to an environment of autonomous vehicle (AV); detecting, based on the sensor data, an emergency event in the environment; identifying, based on the sensor data, an emergency vehicle in the environment; and determining, based on a behavior of the emergency vehicle, if the emergency vehicle is responding to the emergency event.

Aspect 2. The computer-implemented method of Aspect 1, further comprising: updating a path of the AV if the emergency vehicle is responding to the emergency event.

Aspect 3. The computer-implemented method of any of Aspects 1 to 2, wherein the behavior of the emergency vehicle comprises a trajectory of the emergency vehicle.

Aspect 4. The computer-implemented method of any of Aspects 1 to 3, wherein the behavior of the emergency vehicle comprises a status of one or more lights mounted on the emergency vehicle.

Aspect 5. The computer-implemented method of any of Aspects 1 to 4, wherein the behavior of the emergency vehicle comprises a status of one or more acoustic devices associated with the emergency vehicle.

Aspect 6. The computer-implemented method of any of Aspects 1 to 5, wherein the emergency event comprises: a collision between two or more vehicles, a fire, a collapsed building, a collapsed roadway, an injured pedestrian, or a combination thereof.

Aspect 7. The computer-implemented method of any of Aspects 1 to 6, wherein the sensor data comprises: Light Detection and Ranging (LIDAR) data, camera data, radar data, microphone or a combination thereof.

Aspect 8. The computer-implemented method of any of Aspects 1 to 7, wherein determining if the emergency vehicle is responding to the emergency event, further comprises: determining an emergency vehicle type, an emergency vehicle location, an emergency type, an emergency location, or a combination thereof.

Aspect 9. The computer-implemented method of Aspect 8, wherein determining if the emergency vehicle is responding to the emergency event, further comprises: calculating a correlation score using at least two of the emergency vehicle type, the emergency vehicle location, the emergency type, and the emergency location.

Aspect 10. The computer-implemented method of Aspect 9, wherein determining if the emergency vehicle is responding to the emergency event, further comprises: determining an intent of the emergency vehicle using the correlation score.

Aspect 11. The computer-implemented method of Aspect 10, further comprising: displaying at least one of the emergency vehicle type, the emergency vehicle location, the emergency type, the emergency location, the correlation score or the emergency vehicle intent to a human operator.

Aspect 12. The computer-implemented method of Aspect 11, further comprising: determining an adjusted plan for the AV using at least one of the emergency vehicle type, the emergency vehicle location, the emergency type, the emergency location, the correlation score, the emergency vehicle intent, a human operator response, or a combination thereof.

Aspect 13. An apparatus comprising: at least one memory; and at least one processor coupled to the at least one memory, the at least one processor configured to: receive sensor data pertaining to an environment of autonomous vehicle (AV); detect, based on the sensor data, an emergency event in the environment; identify, based on the sensor data, an emergency vehicle in the environment; and determine, based on a behavior of the emergency vehicle, if the emergency vehicle is responding to the emergency event.

Aspect 14. The apparatus of Aspect 13, wherein the at least one processor is further configured to: update a path of the AV if the emergency vehicle is responding to the emergency event.

Aspect 15. The apparatus of any of Aspects 13-14, wherein the behavior of the emergency vehicle comprises a trajectory of the emergency vehicle.

Aspect 16. The apparatus of any of Aspects 13-15, wherein the behavior of the emergency vehicle comprises a status of one or more lights mounted on the emergency vehicle.

Aspect 17. The apparatus of any of Aspects 13-16, wherein the behavior of the emergency vehicle comprises a status of one or more acoustic devices associated with the emergency vehicle.

Aspect 18. The apparatus of any of Aspects 13-17, wherein the emergency event comprises: a collision between two or more vehicles, a fire, a collapsed building, a collapsed roadway, an injured pedestrian, or a combination thereof.

Aspect 19. The apparatus of any of Aspects 13-18, wherein the sensor data comprises: Light Detection and Ranging (LIDAR) data, camera data, radar data, microphone or a combination thereof.

Aspect 20. A non-transitory computer-readable storage medium comprising at least one instruction for causing a computer or processor to: receive sensor data pertaining to an environment of autonomous vehicle (AV); detect, based on the sensor data, an emergency event in the environment; identify, based on the sensor data, an emergency vehicle in the environment; and determine, based on a behavior of the emergency vehicle, if the emergency vehicle is responding to the emergency event.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
receiving sensor data pertaining to an environment of autonomous vehicle (AV);
detecting, based on the sensor data, an emergency event in the environment;
identifying, based on the sensor data, an emergency vehicle in the environment; and
determining, based on a behavior of the emergency vehicle, if the emergency vehicle is responding to the emergency event.

2. The computer-implemented method of claim 1, further comprising:
updating a path of the AV if the emergency vehicle is responding to the emergency event.

3. The computer-implemented method of claim 1, wherein the behavior of the emergency vehicle comprises a trajectory of the emergency vehicle.

4. The computer-implemented method of claim 1, wherein the behavior of the emergency vehicle comprises a status of one or more lights mounted on the emergency vehicle.

5. The computer-implemented method of claim 1, wherein the behavior of the emergency vehicle comprises a status of one or more acoustic devices associated with the emergency vehicle.

6. The computer-implemented method of claim 1, wherein the emergency event comprises: a collision between two or more vehicles, a fire, a collapsed building, a collapsed roadway, an injured pedestrian, or a combination thereof.

7. The computer-implemented method of claim 1, wherein the sensor data comprises: Light Detection and Ranging (LIDAR) data, camera data, radar data, microphone or a combination thereof.

8. The computer-implemented method of claim 1, wherein determining if the emergency vehicle is responding to the emergency event, further comprises:
determining an emergency vehicle type, an emergency vehicle location, an emergency type, an emergency location, or a combination thereof.

9. The computer-implemented method of claim 8, wherein determining if the emergency vehicle is responding to the emergency event, further comprises:
calculating a correlation score using at least two of the emergency vehicle type, the emergency vehicle location, the emergency type, and the emergency location.

10. The computer-implemented method of claim 9, wherein determining if the emergency vehicle is responding to the emergency event, further comprises:
determining an intent of the emergency vehicle using the correlation score.

11. The computer-implemented method of claim 10, further comprising:
displaying at least one of the emergency vehicle type, the emergency vehicle location, the emergency type, the emergency location, the correlation score or the emergency vehicle intent to a human operator.

12. The computer implemented method of claim 11, further comprising:
determining an adjusted plan for the AV using at least one of the emergency vehicle type, the emergency vehicle location, the emergency type, the emergency location, the correlation score, the emergency vehicle intent, a human operator response, or a combination thereof.

13. An apparatus comprising:
at least one memory; and
at least one processor coupled to the at least one memory, the at least one processor configured to:
receive sensor data pertaining to an environment of autonomous vehicle (AV);
detect, based on the sensor data, an emergency event in the environment;
identify, based on the sensor data, an emergency vehicle in the environment; and
determine, based on a behavior of the emergency vehicle, if the emergency vehicle is responding to the emergency event.

14. The apparatus of claim 13, wherein the at least one processor is further configured to:
update a path of the AV if the emergency vehicle is responding to the emergency event.

15. The apparatus of claim 13, wherein the behavior of the emergency vehicle comprises a trajectory of the emergency vehicle.

16. The apparatus of claim 13, wherein the behavior of the emergency vehicle comprises a status of one or more lights mounted on the emergency vehicle.

17. The apparatus of claim 13, wherein the behavior of the emergency vehicle comprises a status of one or more acoustic devices associated with the emergency vehicle.

18. The apparatus of claim 13, wherein the emergency event comprises: a collision between two or more vehicles, a fire, a collapsed building, a collapsed roadway, an injured pedestrian, or a combination thereof.

19. The apparatus of claim 13, wherein the sensor data comprises: Light Detection and Ranging (LIDAR) data, camera data, radar data, microphone or a combination thereof.

20. A non-transitory computer-readable storage medium comprising at least one instruction for causing a computer or processor to:
receive sensor data pertaining to an environment of autonomous vehicle (AV);
detect, based on the sensor data, an emergency event in the environment;
identify, based on the sensor data, an emergency vehicle in the environment; and
determine, based on a behavior of the emergency vehicle, if the emergency vehicle is responding to the emergency event.
